(19) United States
(12) Patent Application Publication
(10) Pub. No.: US 2012/0194343 A1
(43) Pub. Date: Aug. 2, 2012

(54) DRIVING AID

(76) Inventor: GARY LIVINGSTON, Bloomfield, IA (US)

(21) Appl. No.: 13/019,452

(22) Filed: Feb. 2, 2011

(51) Int. Cl. G08B 23/00

(52) U.S. Cl. 340/575

(57) ABSTRACT

A driver alert system to assist a driver in remaining alert comprising: a cooling element; a sleeve, where said sleeve receives and holds the cooling element; a plurality of body attachments, where said body attachments extend from the sleeve and may be attached to the driver's skin in order to transfer a cooling sensation to the driver's skin; a power cord, where said power cord supplies power to the sleeve. The sleeve may include an extension for the power cord that may be plugged into the DC power outlet of a vehicle such as a cigarette lighter. In one particular embodiment, the plurality of body attachments include: a Velcro strap, where the strap wraps around a driver's arm or wrist; and a headphone, where the headphone includes cooling templates that may be placed upon the driver's head.

### BACKGROUND OF THE INVENTION

1. Field of Invention

The present invention relates to a driving aid to assist in preventing drowsiness or falling asleep while driving.

2. Description of Related Art

Many accidents and deaths are caused each year due to driver fatigue where drivers may doze off or fall asleep while driving. Many times this happens to individuals that are taking long drives over the road or to commercial drivers who spend many hours on the road at a time. Dozing off while driving can become a very dangerous situation for the driver and other vehicles that may be on the road.

In order to prevent dozing off or sleeping while driving many drivers may use techniques such as drinking coffee, caffeine, energy drinks or other stimulants while driving in order to stay awake and alert. Other approaches that drivers use are opening a window, playing loud music or possibly talking on the phone.

Some specific devices have been developed in the prior art to awaken drivers that may be slipping into a drowsy condition while driving. Such a device is disclosed in U.S. Pat. No. 6,445,303 which discloses an apparatus and method for waking a sleeping driver that involves the administration of electrical shock by an element that is integrated in or coupled to the vehicle steering wheel; or by elements worn by the driver or secured to the driver's clothing. U.S. Pat. No. 6,107,922 discloses a self-contained headset sleep or fatigue alarm for a driver of a vehicle that contains a set of arms extending from the housing around the driver's head to the area under the driver's lower jaw. Should the driver have an involuntary relaxation of the lower jaw, the buzzer activates or vibrates it to awaken the driver. U.S. Pat. No. 5,689,241 discloses a sleep detection and driver alert apparatus that includes lenses and electronic detection mechanisms for monitoring the effects of early stages of sleep by means of an infrared auto focusing digital imaging stabilizing lenses with its own capability.

As noted above, a number of the devices in the prior art include electronic means to alert or to signal the impeding sleep of a driver, many of these devices however fail to prevent the sleep from incurring and are very dependent upon electrical sensors and readings from the driver. Further devices are needed in this area to actually prevent the driver from drifting into a sleep or a drowsy state and therefore endangering the life of the driver and other drivers on the road.

### SUMMARY OF THE INVENTION

The present invention relates to a driver alert system to assist a driver in remaining alert comprising: a cooling element; a sleeve, where said sleeve receives and holds the cooling element; a plurality of body attachments, where said body attachments extend from the sleeve and may be attached to the driver's skin in order to transfer a cooling sensation to the driver's skin; a power cord, where said power cord supplies power to the sleeve. The sleeve may include an extension for the power cord that may be plugged into the DC power outlet of a vehicle such as a cigarette lighter. In one particular embodiment, the plurality of body attachments include: a Velcro strap, where the strap wraps around a driver's arm or wrist; and a headphone, where the headphone includes cooling templates that may be placed upon the driver's head.

### BRIEF DESCRIPTION OF DRAWINGS

FIG. 1 depicts the driver assistance system according to the present invention.

### DETAILED DESCRIPTION

The present invention provides a driver alerting system that enables a driver to remain alert while operating a motor vehicle. The Driver Alert System according to the present invention is electrically powered and applies a cooling sensation to various parts of a driver's body. The cooling sensation applied during the use of the alert system according to the present invention enables the driver to remain alert and therefore prevent the onset of drowsiness while operating a vehicle.

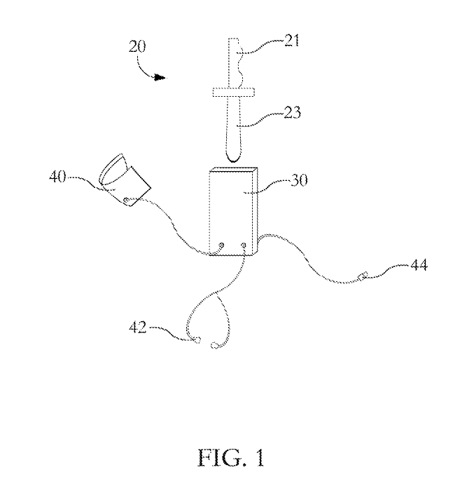

A Driver Alert System 20 is depicted in FIG. 1. The components of the Driver Alert System 20 include a Sleeve 30 that holds a Cooling Element 23 and attachments that are attached to the driver's body. The Sleeve 30 includes an extension for a power cord that may be plugged into the DC power outlet of a vehicle such as a cigarette lighter. Further extending from the Sleeve 30 are components that may be attached to the driver's body such as a Velcro strap that may be wrapped around a driver's arm or wrist and a headphone with Cooling Templates 42 that may be placed upon the driver's head. The Sleeve 30 transports the cooling sensations the Cooling Element 23 that has a Handle 22 that provides for the manipulation and insertion inside of the Sleeve 30. Once the Cooling Element 23 is placed inside the Sleeve 30, the apparatus is connected to power via the Power Outlet 44 and the driver straps the Velcro sleeve 30 on an arm and the headphone temples may be placed upon the driver's temples or near the jugular veins so that this cooling effects are applied to these areas.

Application of the cooling sensations to these particular areas has been known to keep a driver's awareness acute and to prevent the onslaught of fatigue or dozing off. A driver may utilize the Alert System 20 according to the present invention so that they may remain awake until reaching a suitable area to stop and obtain rest or sleep. The Driver Alert System 20 essentially applies a cold compress with a flow of a low electrical charge that patches through to the applied body part. Although this invention may be powered via a DC power voltage source, it may alternatively be plugged into an inverter and supplied power through an AC voltage source. One advantage of using the Alert System 20 according to the present invention is that the driver's hands remain free so that they may operate their vehicle nor is the driver subjected to electrical charges or sudden alarms that may be false alarms due to the inadvertent of triggering of sensors that have been described above in the prior art. The cold compress and the cooling sensation applies a consistent 35-degree Fahrenheit cooling sensation to the driver's skin, so that these attachment devices may be placed comfortably under the jawbone or wrapped around wrists or even placed over the temples of the driver's head via their headphones.

The Alerting System 20 according to the present invention therefore obviates the need for excessive caffeine, loud music or other conventional and ineffective methods of remaining alert while operating a vehicle. The Alerting System 20 may also include a neck attachment that allows the cooling element and sensations to be applied directly to the driver's neck area.

What is claimed is:

1. A driver alert system to assist a driver in remaining alert comprising:
a. a cooling element;
b. a sleeve, where said sleeve receives and holds the cooling element;
c. a plurality of body attachments, where said body attachments extend from the sleeve and may be attached to the driver's skin in order to transfer a cooling sensation to the driver's skin;
d. a power cord, where said power cord supplies power to the sleeve.

2. The driver alert system according to claim 1, where the sleeve includes an extension for the power cord that may be plugged into the DC power outlet of a vehicle such as a cigarette lighter.

3. The driver alert system according to claim 1, where the plurality of body attachments include: a Velcro strap, where the strap wraps around a driver's arm or wrist; and a headphone, where the headphone includes cooling templates that may be placed upon the driver's head.

4. The driver alert system according to claim 1, where the sleeve transports the cooling sensations from the cooling element and said cooling element includes a handle that provides a means for manipulation and insertion inside of the sleeve.
